(19) United States
(12) Patent Application Publication
(10) Pub. No.: US 2021/0252908 A1
(43) Pub. Date: Aug. 19, 2021

(54) RIM PROTECTOR AND METHOD OF USING THE SAME

(71) Applicant: Noddy Singh, Hicksville, NY (US)

(72) Inventor: Noddy Singh, Hicksville, NY (US)

(21) Appl. No.: 17/179,928

(22) Filed: Feb. 19, 2021

Related U.S. Application Data
(60) Provisional application No. 62/978,396, filed on Feb. 19, 2020.

(51) Int. Cl. B60B 7/01

(52) U.S. Cl. CPC B60B 7/01; B60B 2900/212; B60B 2310/318

(57) ABSTRACT

The present disclosure is directed to a device and a method of using the device. The device includes a substantially circular ring dimensioned to extend around an outer flange of an automobile rim, the substantially circular ring comprising a first surface and a second surface opposite to the first surface, an adhesive that covers at least a portion of the first surface and a first post extending substantially orthogonally from the first surface of the substantially circular ring, the first post configured to extend into a space between the outer flange and an automobile tire.

### CROSS REFERENCE TO RELATED APPLICATIONS

This application claims the benefit of priority from U.S. Provisional Application No. 62/978,396, filed Feb. 19, 2020, the contents of which are incorporated herein by reference in its entirety.

### BACKGROUND OF THE DISCLOSURE

Typical automobile rims can be damaged by scraping or rubbing against fixed objects, such as curbs. This damage can easily occur and can be expensive to fix.

What is desired is a device and method for protecting an automobile's rim from damage. Embodiments of the present disclosure provide methods that address the above and other issues.

### SUMMARY OF THE DISCLOSURE

The present disclosure is directed to a device and a method of using the device. The device includes a substantially circular ring dimensioned to extend around an outer flange of an automobile rim, the substantially circular ring comprising a first surface and a second surface opposite to the first surface, an adhesive that covers at least a portion of the first surface and a first post extending substantially orthogonally from the first surface of the substantially circular ring, the first post configured to extend into a space between the outer flange and an automobile tire.

### BRIEF DESCRIPTION OF THE DRAWINGS

The present disclosure will be better understood by reference to the following drawings of which:

FIG. 1 is a perspective view of a portion of an automobile.

FIG. 2 is a cross sectional view of a tire, rim and the disclosed device;

FIG. 3 is a magnified view of a portion of FIG. 2; and

FIG. 4 is a perspective view of an embodiment of the disclosed device.

### DETAILED DESCRIPTION OF THE DISCLOSURE

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

In the discussion and claims herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10%, or any point therein.

As used herein, the term “substantially”, or “substantial”, is equally applicable when used in a negative connotation to refer to the complete or near complete lack of an action, characteristic, property, state, structure, item, or result. For example, a surface that is “substantially” flat would either be completely flat, or so nearly flat that the effect would be the same as if it were completely flat.

As used herein terms such as “a”, “an” and “the” are not intended to refer to only a singular entity, but include the general class of which a specific example may be used for illustration.

As used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc. In yet another illustration, reference herein to a range of from “5 to 10” includes whole numbers of 5, 6, 7, 8, 9, and 10, and fractional numbers 5.1, 5.2, 5.3, 5.4, 5.5, 5.6, 5.7, 5.8, 5.9, etc.

As used herein, the term “automobile” and/or “automotive” and grammatical variants thereof, refer to any motor vehicle (gasoline and/or electrically powered) including light and heavy vehicles such as a car, truck, sports utility vehicle (SUV), van, bus, snowmobile, all terrain vehicle (ATV), scooter, motorcycle, tractor, construction vehicle, military vehicle, and the like.

As used herein, the term “tire” refers to a covering for the outwardly facing surface of a rim that acts as an intermediary between the wheel and the ground surface over against which the wheel assembly turns, and can be subject to internal inflation pressure, or not, during use.

As used herein, the term “rim” refers to a substantially cylindrical rigid structure upon which a tire or tire sections mount or are otherwise secured.

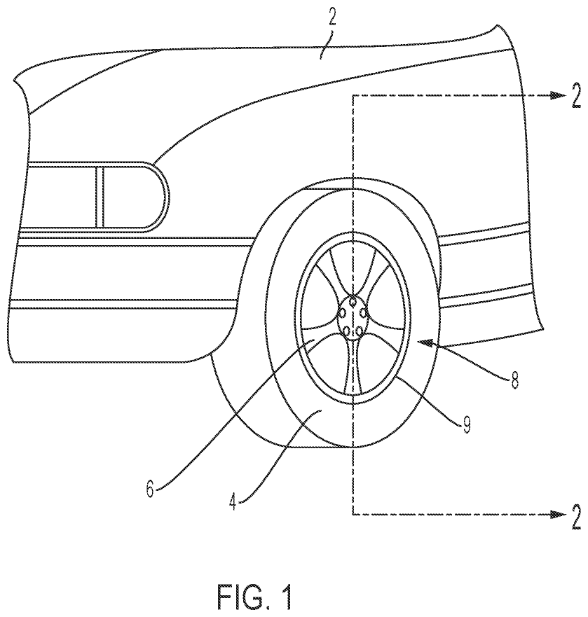

An embodiment of the claimed device is shown in FIG. 1, which is a view of a portion of an automobile 2, which has a tire 4 extending around a rim 6, wherein a device 8 is attached to a portion of the rim 6. As typical, the rim 6 is substantially circular. The device 8 can be dimensioned for the size of the rim 6, with the device 8 being a substantially circular ring 9 dimensioned to extend around an outer flange of the rim 6.

The substantially circular ring 9 of the device 8 can be a single piece, or multiple pieces joined together. The substantially circular ring 9 of the device 8 can be formed of any suitable material, such as metal, carbon based materials, plastics, rubbers, and combinations thereof. Also, the substantially circular ring 9 of the device 8 can be coated or painted to be any suitable color and finish.

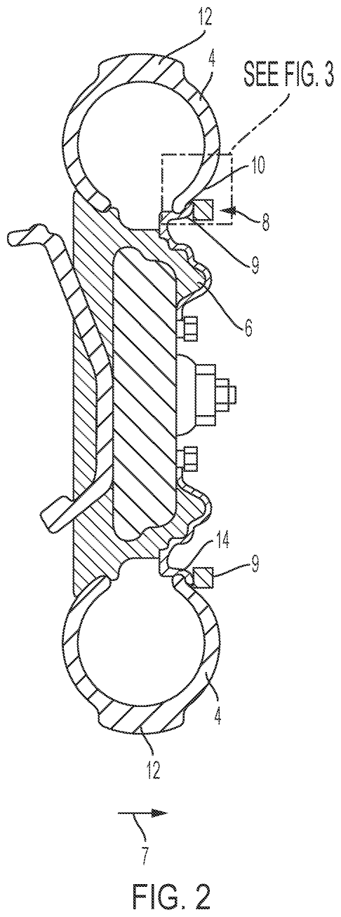

A cross section along line 2 is shown in FIG. 2, without the automobile 2 being shown. Although only a portion of the device 8 can be seen, all cross sections of the device 8 are substantially the same or substantially similar.

FIG. 2 is a cross-sectional view along the line ‘2’ of FIG. 1. As seen in FIG. 2, the tire 4 extends around the rim 6 in a typical way, such that a portion of the tire 4 extends to an internal area of the rim 6, past an outer flange 14 of the rim 6. A tread 12 of the tire 4 is configured to contact a road surface (not shown). The device 8 extends around the outer flange 14 of the rim 6 and can be (although not shown in FIG. 2) the furthest point in the direction of arrow 7, which is pointing away from the automobile (shown in FIG. 1).

Although in this view the device 8 extends around the outer flange 14 of the rim 6, in other embodiments, the device 8 can be dimensioned to extend around another portion of the rim 6 that is further, or less far, that the outer flange 14 in the direction of arrow 7.

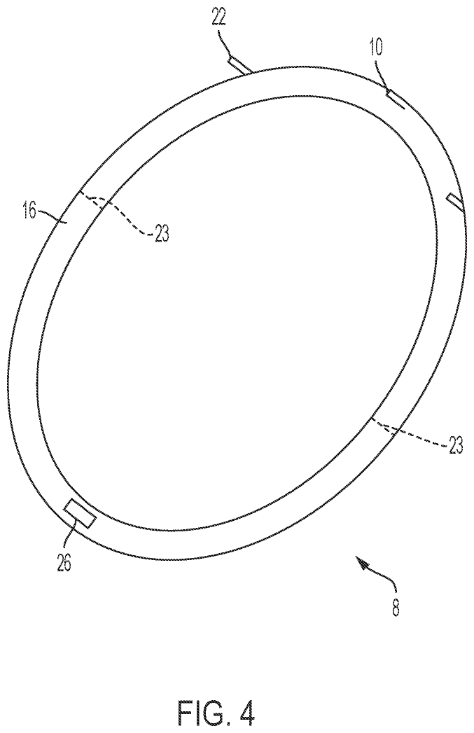

A magnified view of the device 8 and the rim 6 is shown in FIG. 4, in the area of box 3′ of FIG. 2.

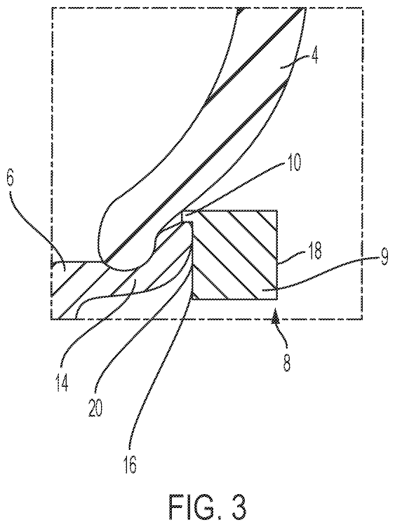

FIG. 3 illustrates the tire 4 interacting with the rim 6. As seen in FIG. 3, the substantially circular ring 9 has a substantially rectangular cross-section, but, in other embodiments, the substantially circular ring 9 can be curved, oval shaped, another polygon, having 3, 5, 6, or more sides, or an erratic shape.

The substantially circular ring 9 includes a first surface 16 and a second surface 18, which is opposite to the first surface. As can be seen partially in FIG. 2, and more so in FIG. 1, the second surface 18 is substantially smooth, and in this embodiment, does not include any protrusions in a direction opposite to arrow 7. In other embodiments, the second surface 18 can include one or more protrusions in a direction opposite to arrow 7.

Referring to FIG. 3, in this view, an adhesive 20 is shown as covering a portion of the first surface 16. In other embodiments, the adhesive 20 can cover substantially all, or all of the first surface 16. This adhesive 20 can be any suitable material that can secure the substantially circular ring 9 to the flange 14, such as any suitable epoxy, glue, resin, and/or acrylic adhesive. Although not shown, a film can extend over the adhesive 10, so that during the device 8 can be handled without the adhesive 20 being exposed.

In this view the first post 10 can also be seen, extending substantially orthogonally from the first surface 16 of the substantially circular ring 9. The first post 10 is configured to extend into the space between the outer flange 14 and the tire 4 and can be any suitable shape and size to extend into this space. Although not shown, an adhesive (which can be the same or different from adhesive 20) can extend over any portion of the first post 10.

FIG. 4 is a perspective view of the device 8, separate from the rim and tire. This view is of the first surface 16, which includes the first post 10. In this view, neither the adhesive nor the film covering the adhesive are shown.

Optionally, the device 8 can include a second post 22, extending substantially orthogonally from the first surface 16 of the substantially circular ring 9.

The second post 22 is configured to extend into the space between the outer flange and the tire (shown in FIGS. 2 and 3) and can be any suitable shape and size to extend into this space. Although not shown, an adhesive (which can be the same or different from adhesive 20) can extend over any portion of the second post 22.

Two imaginary dashed lines 23 are seen in FIG. 4, and demonstrate about 180° of circumference of the substantially circular ring 9. As can be seen in FIG. 4, both the first post 10 and the second post 22 are within the 180° portion of the substantially circular ring 9, with the first post 10 being less than 180° from the second post 22 along the circumference of the substantially circular ring 9.

Optionally, the device 8 can include both the second post 22 and a third post 24, with the third post 24 extending substantially orthogonally from the first surface 16 of the substantially circular ring 9.

The third post 24 is configured to extend into the space between the outer flange and the tire (shown in FIGS. 2 and 3) and can be any suitable shape and size to extend into this space. Although not shown, an adhesive (which can be the same or different from adhesive 20) can extend over any portion of the third post 24.

Referring again to the two dashed lines 23 seen in FIG. 4, each of the first post 10, the second post 22 and the third post 24 are within the 180° portion of the substantially circular ring 9, with the first post 10 being less than 180° from both of the second post 22 and the third post 24 along the circumference of the substantially circular ring 9.

Although the first post 10, the second post 22 and the third post 24 are being in specific locations on the substantially circular ring 9, they can be placed in any suitable position about the substantially circular ring 9.

As also shown in FIG. 4, a weighted portion 26 of the substantially circular ring 9 is shown, substantially near the bottom of the substantially circular ring 9, and substantially opposite the first post 10. This weighted portion 26 can be an embedded portion, within the cross-sectional area of the substantially circular ring 9, and can substantially offset the weight of one or more of the first post 10, the second post 22 and the third post 24.

In other embodiments, the weighted portion 26 can be a weight attached to a surface of the substantially circular ring 9, substantially near the bottom of the substantially circular ring 9, and substantially opposite the first post 10. This weighted portion 26 can be external to the cross-sectional area of the substantially circular ring 9, and can substantially offset the weight of one or more of the first post 10, the second post 22 and the third post 24.

A method for applying the device 8 to a rim 6 will now be discussed in reference to FIGS. 1-4.

First, a user can remove a film from the adhesive 20 and then the user can insert the first post 10 into the space between the outer flange 14 and the tire 4. Next, the user can apply a pressure to the second surface 18, towards the outer flange 14, around at least a portion of the circumference of the substantially circular ring 9.

In this embodiment, the first post 10, prior to the application of pressure to the second surface 18, can substantially support the weight of the substantially circular ring 9, and can also substantially maintain an alignment between the circumference of the substantially circular ring 9 and the circumference of the outer flange 14.

In another embodiment, prior to application of pressure to the second surface 18, the user can insert both the first post 10 and the second post 22 into the space between the outer flange 14 and the tire 4. Next, the user can apply a pressure to the second surface 18, towards the outer flange 14, around at least a portion of the circumference of the substantially circular ring 9.

In this embodiment, both the first post 10 and the second post 22, prior to the application of pressure to the second surface 18, can substantially support the weight of the substantially circular ring 9, and can also substantially maintain an alignment between the circumference of the substantially circular ring 9 and the circumference of the outer flange 14.

In another embodiment, prior to application of pressure to the second surface 18, the user can insert each of the first post 10, the second post 22 and the third post 24 into the space between the outer flange 14 and the tire 4. Next, the user can apply a pressure to the second surface 18, towards the outer flange 14, around at least a portion of the circumference of the substantially circular ring 9.

In this embodiment, each of the first post 10, the second post 22 and the third post 24, prior to the application of pressure to the second surface 18, can substantially support the weight of the substantially circular ring 9, and can also substantially maintain an alignment between the circumference of the substantially circular ring 9 and the circumference of the outer flange 14.

After a period of time the substantially circular ring 9 can be removed from the rim 6 though application of any suitable adhesive remover (such as a solvent, acid, or other material) can be applied to the adhesive 20, such that adhesive 20 substantially releases the substantially circular ring 9 from the rim 6.

This removal of the device 8 can occur after the device 8 is damaged, such as by scraping the device 8 on a curb during parking of the automobile. Thus, the device 8 acts as a protector of the material of the rim 6, protecting the rim 6 from damage due to impacts with other objects.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. A device, the device comprising:
a substantially circular ring dimensioned to extend around an outer flange of an automobile rim, the substantially circular ring comprising a first surface and a second surface opposite to the first surface;
an adhesive that covers at least a portion of the first surface; and
a first post extending substantially orthogonally from the first surface of the substantially circular ring, the first post configured to extend into a space between the outer flange and an automobile tire.

2. The device of claim 1, wherein the adhesive covers substantially all of the first surface.

3. The device of claim 1, wherein the device further comprises a film that extends over the adhesive.

4. The device of claim 1, wherein an adhesive covers at least a portion of the first post.

5. The device of claim 1, wherein the device further comprises a second post, the second post extending substantially orthogonally from the first surface of the substantially circular ring.

6. The device of claim 5, wherein an adhesive covers at least a portion of the second post.

7. The device of claim 5, wherein the first post is less than 180° from the second post along a circumference of the substantially circular ring.

8. The device of claim 1, wherein the device further comprises a third post, the third post extending substantially orthogonally from the first surface of the substantially circular ring.

9. The device of claim 8, wherein an adhesive covers at least a portion of the third post.

10. The device of claim 8, wherein the first post is less than 180° from both of the second post and the third post along a circumference of the substantially circular ring.

11. The device of claim 1, wherein the device comprises a weighted portion of the substantially circular ring that is about 180° along a circumference of the substantially circular ring from the first post.

12. The device of claim 1, wherein the device further comprises a weight attached to the substantially circular ring, wherein the weight is about 180° along a circumference of the substantially circular ring from the first post.

13. A method of applying a device to an automobiles rim, the method comprising:
removing a film from an adhesive, the adhesive covering at least a portion of a first surface of a substantially circular ring dimensioned to extend around an outer flange of the automobile rim, the substantially circular ring comprising the first surface and a second surface opposite to the first surface;
inserting a first post, the first post extending substantially orthogonally from the first surface of the substantially circular ring, into a space between the outer flange and an automobile tire; and
applying pressure to the second surface of the substantially circular ring towards the outer flange.

14. The method of claim 13, wherein the first post is configured to maintain an alignment between the substantially circular ring and a circumference of the outer flange.

15. The method of claim 13, wherein the method further comprises inserting a second post, the second post extending substantially orthogonally from the first surface of the substantially circular ring, into the space between the outer flange and the automobile tire.

16. The method of claim 15, wherein the first post and the second post are configured to maintain an alignment between the substantially circular ring and a circumference of the outer flange.

17. The method of claim 15, wherein the method further comprises inserting a third post, the third post extending substantially orthogonally from the first surface of the substantially circular ring, into the space between the outer flange and the automobile tire.

18. The method of claim 17, wherein the first post, the second post and the third post are configured to maintain an alignment between the substantially circular ring and a circumference of the outer flange.
